(19) United States
(12) Patent Application Publication
(10) Pub. No.: US 2017/0002630 A1
(43) Pub. Date: Jan. 5, 2017

(54) METHOD OF PERFORMING ADDITIONAL OILFIELD OPERATIONS ON EXISTING WELLS

(71) Applicant: Schlumberger Technology Corporation, Sugar Land, TX (US)

(72) Inventors: Ivan Priezzhev, Houston, TX (US); Meyer Bengio, Houston, TX (US); Garrett Jess Lindsay, Houston, TX (US)

(21) Appl. No.: 14/790,203

(22) Filed: Jul. 2, 2015

(51) Int. Cl. E21B 41/00; E21B 7/00; E21B 49/00; E21B 43/26; E21B 43/11; G06F 17/30; E21B 43/16

(52) U.S. Cl. CPC E21B 41/0092; G06F 17/30598; G06F 17/30424; E21B 7/00; E21B 43/16; E21B 43/26; E21B 43/11; E21B 49/00

(57) ABSTRACT

A method for performing additional oilfield operations on existing wells. The existing wells extending into a subterranean formation, and having oilfield operations previously performed to generate production. The method involves generating oilfield data (e.g., production rate) for each of the existing wells in a target area; generating oilfield parameters for each of the existing wells in the target area (the oilfield parameters including geological potential, drilling quality, and completion quality); identifying candidate wells from the existing wells by determining which of the existing wells within the target area have a maximum geological potential, a maximum drilling quality, and a minimum completion quality; and performing the additional oilfield operations (e.g., re-stimulating) on at least one of the identified wells.

### BACKGROUND

The present disclosure relates to techniques for performing oilfield operations. More particularly, the present disclosure relates to techniques for performing oilfield operations, such as stimulating, fracturing, refracturing, and/or producing.

Oilfield operations may be performed to locate and gather valuable downhole fluids, such as hydrocarbons. Oilfield operations may include, for example, surveying, drilling, downhole evaluation, completion, production, stimulation, and oilfield analysis. Surveying may involve seismic surveying using, for example, a seismic truck to send and receive downhole signals. Drilling may involve advancing a downhole tool into the earth to form a wellbore. Downhole evaluation may involve deploying a downhole tool into the wellbore to take downhole measurements and/or to retrieve downhole samples. Completion may involve cementing and casing a wellbore in preparation for production. Production may involve deploying production tubing into the wellbore for transporting fluids from a reservoir to the surface. Stimulation may involve, for example, perforating, fracturing, injecting, and/or other stimulation operations, to facilitate production of fluids from the reservoir.

Oilfield operations may be performed at one or more locations in order to produce hydrocarbons from subsurface reservoirs. Wellbores may be drilled at the location(s) to reach a desired reservoir. In some cases, simulations may be performed as part of the wellsite operations. Examples of simulations are provided in US Patent Application No. 2012/0179444, the entire contents of which is hereby incorporated by reference herein.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In at least one aspect, the disclosure relates to a method for performing additional oilfield operations on existing wells. The existing wells extending into a subterranean formation, and having oilfield operations previously performed to generate production. The method involves generating oilfield data (e.g., production rate) for each of the existing wells in a target area; generating oilfield parameters for each of the existing wells in the target area (the oilfield parameters including geological potential, drilling quality, and completion quality); identifying candidate wells from the existing wells by determining which of the existing wells within the target area have a maximum geological potential, a maximum drilling quality, and a minimum completion quality; and performing the additional oilfield operations (e.g., re-stimulating) on at least one of the identified wells.

### BRIEF DESCRIPTION OF THE DRAWINGS

Embodiments of the method and system for placement of oilfield operation are described with reference to the following figures. The same numbers are used throughout the figures to reference like features and components.

FIGS. 1.1-1.4 are schematic views illustrating various oilfield operations at a wellsite in accordance with one or more embodiments;

FIGS. 2.1-2.4 are schematic views illustrating various data collected by the operations of FIGS. 1.1-1.4 in accordance with one or more embodiments;

FIG. 3.1 is a schematic diagram depicting stimulation of a wellsite in accordance with one or more embodiments;

FIG. 3.2 is a schematic diagram depicting fractures formed about a wellsite during stimulation in accordance with one or more embodiments;

FIG. 4 is a flow diagram illustrating a method of placement of oilfield operations in accordance with one or more embodiments;

FIGS. 5.1 and 5.2 are maps illustrating geological potential for a formation in accordance with one or more embodiments;

FIGS. 6.1 and 6.2 are graphs illustrating drilling quality based on trajectories of wells about a target layer of a formation in accordance with one or more embodiments;

FIGS. 7.1 and 7.2 are a graph and a cross-plot, respectively, illustrating drilling quality based on trajectory variation for a well in accordance with one or more embodiments;

FIGS. 8.1 and 8.2 are a graph and a cross-plot, respectively, illustrating drilling quality based on trajectory variation based on depth in accordance with one or more embodiments; and

FIG. 9 is a map of candidate wells for a formation in accordance with one or more embodiments.

### DETAILED DESCRIPTION

The description that follows includes exemplary systems, apparatuses, methods, and instruction sequences that embody techniques of the subject matter herein. However, it is understood that the described embodiments may be practiced without these specific details.

The present disclosure relates to techniques for performing additional oilfield operations, such as stimulation (e.g., fracturing) and/or restimulation (e.g., re-fracturing), about wells (e.g., wellsites, wellbores and/or portions thereof). Such additional oilfield operations are performed on existing wells having oilfield operations previously performed to generate production. The method may involve using a statistical analysis, such as a multi-factor (or multi-variate predictive or regression), to identify one or more candidate wells for receiving such additional oilfield operations. Identification of candidate wells with promising performance characteristics may be used, for example, to select wells with a potential for generating additional production by performing additional operations, such as refracturing.

The multi-factor analysis may be a non-linear analysis of oil and gas production quality (e.g., production rate (PR)). With this analysis, a pool of candidate wells may be collected based on limiting oilfield parameters, such as geological potential (GP) (e.g., reservoir quality of production). From this pool, candidates may be selected based on other oilfield (or performance) parameters, such as drilling quality (DQ) (e.g., amount of the contact between the well and the reservoir) and completion quality (CQ) (e.g., influence of completion parameters on production), which may potentially affect (e.g., decrease) production.

Candidates for the additional oilfield operation (e.g., re-fracturing) may be identified by combining quality parameters (e.g., GP, DQ, CQ). For example, refracturing candidates may be identified by collecting wells with high GP, and selecting from the collected wells those with optimal DQ and CQ. The multi-factor analysis may be compared with and/or used with other types of analysis, such as Sweet Spot analysis, for validation. The techniques herein may be performed, for example, with modeling techniques, such as those in MANGROVE™ commercially available from SCHLUMBERGER TECHNOLOGY CORPORATION™ at www.slb.com. Examples of simulations are also provided in U.S. Patent Application No. 2012/0179444, previously incorporated by reference herein. The additional oilfield operations, such as re-fracturing, may be performed on the selected existing wells, for example, to generate additional production.

### Oilfield Operations

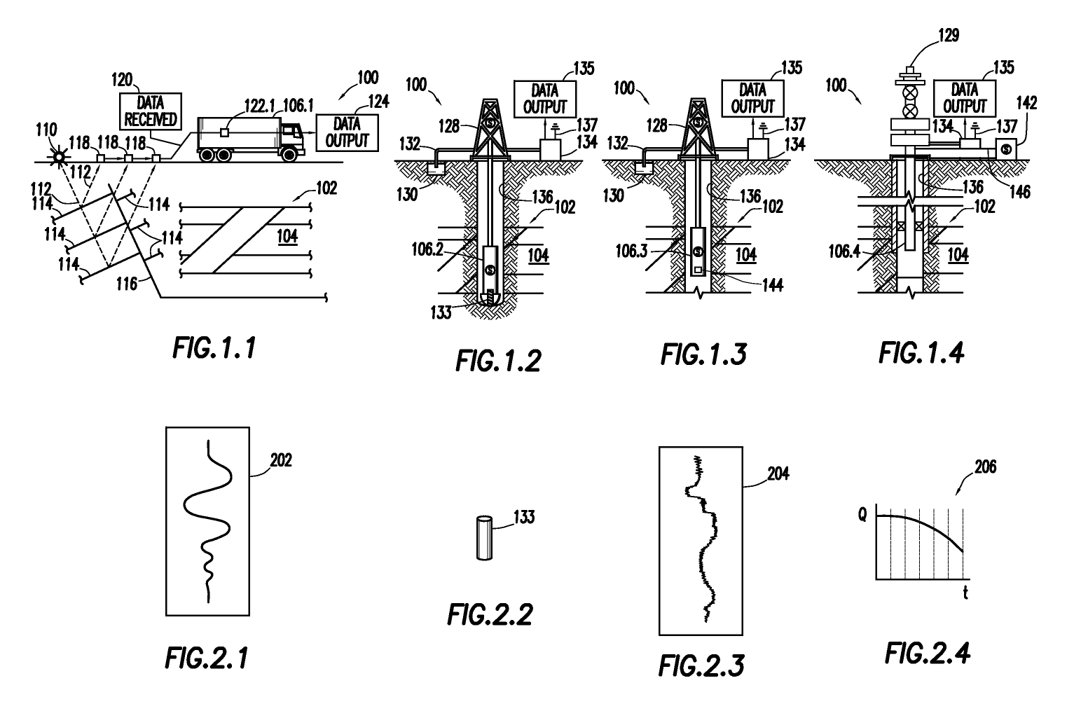

FIGS. 1.1-1.4 depict various oilfield operations that may be performed at a wellsite, and FIGS. 2.1-2.4 depict various information that may be collected at the wellsite. FIGS. 1.1-1.4 depict simplified, schematic views of a representative oilfield or wellsite 100 having subsurface formation 102 containing, for example, reservoir 104 therein and depicting various oilfield operations being performed on the wellsite 100. FIG. 1.1 depicts a survey operation being performed by a survey tool, such as seismic truck 106.1, to measure properties of the subsurface formation. The survey operation may be a seismic survey operation for producing sound vibrations. In FIG. 1.1, one such sound vibration 112 generated by a source 110 reflects off a plurality of horizons 114 in an earth formation 116. The sound vibration(s) 112 may be received in by sensors, such as geophone-receivers 118, situated on the earth's surface, and the geophones 118 produce electrical output signals, referred to as data received 120 in FIG. 1.1.

In response to the received sound vibration(s) 112 representative of different parameters (such as amplitude and/or frequency) of the sound vibration(s) 112, the geophones 118 may produce electrical output signals containing data concerning the subsurface formation. The data received 120 may be provided as input data to a computer 122.1 of the seismic truck 106.1, and responsive to the input data, the computer 122.1 may generate a seismic and microseismic data output 124. The seismic data output may be stored, transmitted or further processed as desired, for example by data reduction.

FIG. 1.2 depicts a drilling operation being performed by a drilling tool 106.2 suspended by a rig 128 and advanced into the subsurface formations 102 to form a wellbore 136 or other channel. A mud pit 130 may be used to draw drilling mud into the drilling tools via flow line 132 for circulating drilling mud through the drilling tools, up the wellbore 136 and back to the surface. The drilling mud may be filtered and returned to the mud pit. A circulating system may be used for storing, controlling or filtering the flowing drilling muds. In this illustration, the drilling tools are advanced into the subsurface formations to reach reservoir 104. Each well may target one or more reservoirs. The drilling tools may be adapted for measuring downhole properties using logging while drilling tools. The logging while drilling tool may also be adapted for taking a core sample 133 as shown, or removed so that a core sample may be taken using another tool.

A surface unit 134 may be used to communicate with the drilling tools and/or offsite operations. The surface unit may communicate with the drilling tools to send commands to the drilling tools, and to receive data therefrom. The surface unit may be provided with computer facilities for receiving, storing, processing, and/or analyzing data from the operation. The surface unit may collect data generated during the drilling operation and produce data output 135 which may be stored or transmitted. Computer facilities, such as those of the surface unit, may be positioned at various locations about the wellsite and/or at remote locations.

Sensors (S), such as gauges, may be positioned about the oilfield to collect data relating to various operations as described previously. As shown, the sensor (S) may be positioned in one or more locations in the drilling tools and/or at the rig to measure drilling parameters, such as weight on bit, torque on bit, pressures, temperatures, flow rates, compositions, rotary speed and/or other parameters of the operation. Sensors (S) may also be positioned in one or more locations in the circulating system.

The data gathered by the sensors may be collected by the surface unit and/or other data collection sources for analysis or other processing. The data collected by the sensors may be used alone or in combination with other data. The data may be collected in one or more databases and/or transmitted on or offsite. All or select portions of the data may be selectively used for analyzing and/or predicting operations of the current and/or other wellbores. The data may be may be historical data, real time data or combinations thereof. The real time data may be used in real time, or stored for later use. The data may also be combined with historical data or other inputs for further analysis. The data may be stored in separate databases, or combined into a single database.

The collected data may be used to perform analysis, such as modeling operations. For example, the seismic data output may be used to perform geological, geophysical, and/or reservoir engineering analysis. The reservoir, wellbore, surface and/or processed data may be used to perform reservoir, wellbore, geological, and geophysical or other simulations. The data outputs from the operation may be generated directly from the sensors, or after some preprocessing or modeling. These data outputs may act as inputs for further analysis.

The data may be collected and stored at the surface unit 134. One or more surface units may be located at the wellsite, or connected remotely thereto. The surface unit may be a single unit, or a complex network of units used to perform the necessary data management functions throughout the oilfield. The surface unit may be a manual or automatic system. The surface unit 134 may be operated and/or adjusted by a user.

The surface unit may be provided with a transceiver 137 to allow communications between the surface unit and various portions of the current oilfield or other locations. The surface unit 134 may also be provided with or functionally connected to one or more controllers for actuating mechanisms at the wellsite 100. The surface unit 134 may then send command signals to the oilfield in response to data received. The surface unit 134 may receive commands via the transceiver or may itself execute commands to the controller. A processor may be provided to analyze the data (locally or remotely), make the decisions and/or actuate the controller. In this manner, operations may be selectively adjusted based on the data collected. Portions of the operation, such as controlling drilling, weight on bit, pump rates or other parameters, may be optimized based on the information. These adjustments may be made automatically based on computer protocol, and/or manually by an operator. In some cases, well plans may be adjusted to select optimum operating conditions, or to avoid problems.

FIG. 1.3 depicts a wireline operation being performed by a wireline tool 106.3 suspended by the rig 128 and into the wellbore 136 of FIG. 1.2. The wireline tool 106.3 may be adapted for deployment into a wellbore 136 for generating well logs, performing downhole tests and/or collecting samples. The wireline tool 106.3 may be used to provide another method and apparatus for performing a seismic survey operation. The wireline tool 106.3 of FIG. 1.3 may, for example, have an explosive, radioactive, electrical, or acoustic energy source 144 that sends and/or receives electrical signals to the surrounding subsurface formations 102 and fluids therein.

The wireline tool 106.3 may be operatively connected to, for example, the geophones 118 and the computer 122.1 of the seismic truck 106.1 of FIG. 1.1. The wireline tool 106.3 may also provide data to the surface unit 134. The surface unit 134 may collect data generated during the wireline operation and produce data output 135 which may be stored or transmitted. The wireline tool 106.3 may be positioned at various depths in the wellbore to provide a survey or other information relating to the subsurface formation.

Sensors (S), such as gauges, may be positioned about the wellsite 100 to collect data relating to various operations as described previously. As shown, the sensor (S) is positioned in the wireline tool 106.3 to measure downhole parameters which relate to, for example porosity, permeability, fluid composition and/or other parameters of the operation.

FIG. 1.4 depicts a production operation being performed by a production tool 106.4 deployed from a production unit or Christmas tree 129 and into the completed wellbore 136 of FIG. 1.3 for drawing fluid from the downhole reservoirs into surface facilities 142. Fluid flows from reservoir 104 through perforations in the casing (not shown) and into the production tool 106.4 in the wellbore 136 and to the surface facilities 142 via a gathering network 146.

Sensors (S), such as gauges, may be positioned about the oilfield to collect data relating to various operations as described previously. As shown, the sensor (S) may be positioned in the production tool 106.4 or associated equipment, such as the Christmas tree 129, gathering network, surface facilities and/or the production facility, to measure fluid parameters, such as fluid composition, flow rates, pressures, temperatures, and/or other parameters of the production operation.

While only simplified wellsite configurations are shown, it will be appreciated that the oilfield or wellsite 100 may cover a portion of land, sea and/or water locations that hosts one or more wellsites. Production may also include injection wells (not shown) for added recovery or for storage of hydrocarbons, carbon dioxide, or water, for example. One or more gathering facilities may be operatively connected to one or more of the wellsites for selectively collecting downhole fluids from the wellsite(s).

It should be appreciated that FIGS. 1.2-1.4 depict tools that can be used to measure not only properties of an oilfield, but also properties of non-oilfield operations, such as mines, aquifers, storage, and other subsurface facilities. Also, while certain data acquisition tools are depicted, it will be appreciated that various measurement tools (e.g., wireline, measurement while drilling (MWD), logging while drilling (LWD), core sample, etc.) capable of sensing parameters, such as seismic two-way travel time, density, resistivity, production rate, etc., of the subsurface formation and/or its geological formations may be used. Various sensors (S) may be located at various positions along the wellbore and/or the monitoring tools to collect and/or monitor the desired data. Other sources of data may also be provided from offsite locations.

The oilfield configuration of FIGS. 1.1-1.4 depicts examples of a wellsite 100 and various operations usable with the techniques provided herein. Part, or all, of the oilfield may be on land, water and/or sea. Also, while a single oilfield measured at a single location is depicted, reservoir engineering may be utilized with any combination of one or more oilfields, one or more processing facilities, and one or more wellsites.

FIGS. 2.1-2.4 are graphical depictions of examples of data collected by the tools of FIGS. 1.1-1.4, respectively. FIG. 2.1 depicts a seismic trace 202 of the subsurface formation of FIG. 1.1 taken by seismic truck 106.1. The seismic trace may be used to provide data, such as a two-way response over a period of time. FIG. 2.2 depicts a core sample 133 taken by the drilling tools 106.2. The core sample may be used to provide data, such as a graph of the density, porosity, permeability or other physical property of the core sample over the length of the core. Tests for density and viscosity may be performed on the fluids in the core at varying pressures and temperatures. FIG. 2.3 depicts a well log 204 of the subsurface formation of FIG. 1.3 taken by the wireline tool 106.3. The wireline log may provide a resistivity or other measurement of the formation at various depts. FIG. 2.4 depicts a production decline curve or graph 206 of fluid flowing through the subsurface formation of FIG. 1.4 measured at the surface facilities 142. The production decline curve may provide the production rate Q as a function of time t.

The respective graphs of FIGS. 2.1, 2.3, and 2.4 depict examples of static measurements that may describe or provide information about the physical characteristics of the formation and reservoirs contained therein. These measurements may be analyzed to define properties of the formation(s), to determine the accuracy of the measurements and/or to check for errors. The plots of each of the respective measurements may be aligned and scaled for comparison and verification of the properties.

FIG. 2.4 depicts an example of a dynamic measurement of the fluid properties through the wellbore. As the fluid flows through the wellbore, measurements are taken of fluid properties, such as flow rates, pressures, composition, etc. As described below, the static and dynamic measurements may be analyzed and used to generate models of the subsurface formation to determine characteristics thereof. Similar measurements may also be used to measure changes in formation aspects over time.

### Stimulation Operations

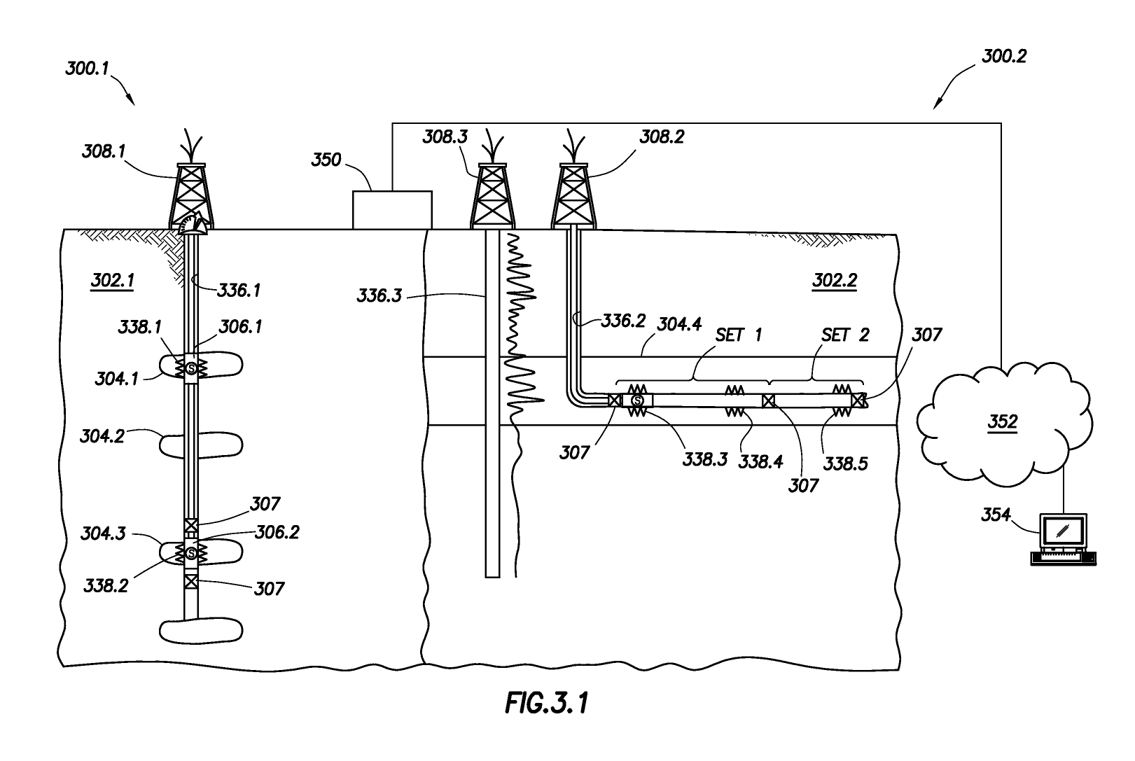

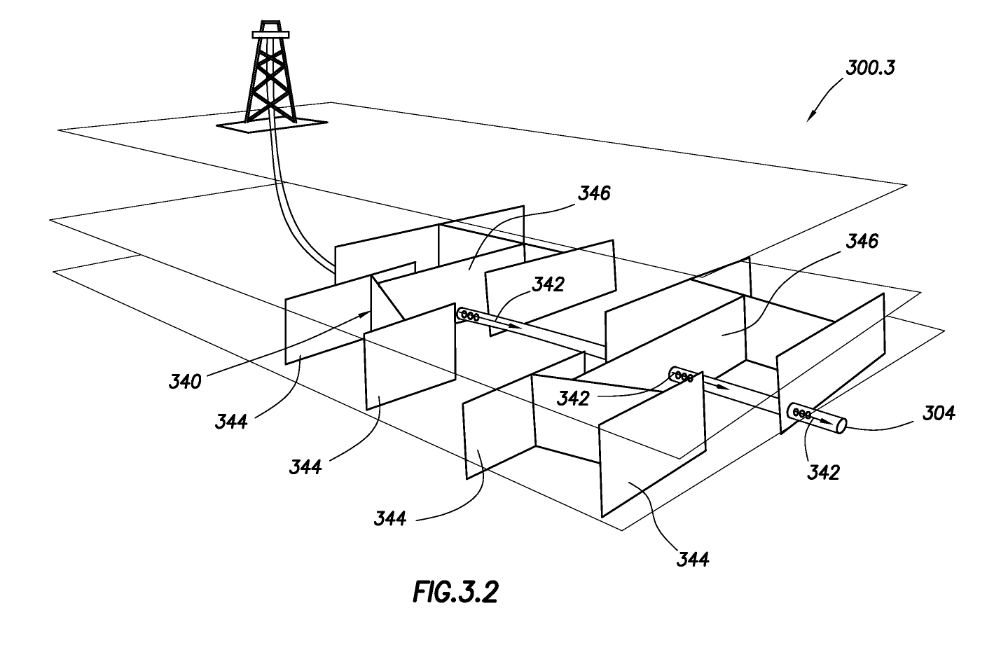

FIGS. 3.1 and 3.2 depict example stimulation operations performed at wellsites 300.1 and 300.2. The wellsite 300.1 includes a rig 308.1 having a vertical wellbore 336.1 extending into a formation 302.1. Wellsite 300.2 includes rig 308.2 having wellbore 336.2 and rig 308.3 having wellbore 336.3 extending therebelow into a subterranean formation 302.2. While the wellsites 300.1 and 300.2 are shown having specific configurations of rigs with wellbores, it will be appreciated that one or more rigs with one or more wellbores may be positioned at one or more wellsites.

Wellbore 336.1 extends from rig 308.1, through unconventional reservoirs 304.1-304.3. Wellbores 336.2 and 336.3 extend from rigs 308.2 and 308.3, respectfully to unconventional reservoir 304.4. As shown, unconventional reservoirs 304.1-304.3 are tight gas sand reservoirs and unconventional reservoir 304.4 is a shale reservoir. One or more unconventional reservoirs (e.g., such as tight gas, shale, carbonate, coal, heavy oil, etc.) and/or conventional reservoirs may be present in a given formation.

The stimulation operations of FIG. 3.1 may be performed alone or in conjunction with other oilfield operations, such as the oilfield operations of FIGS. 1.1 and 1.4. For example, wellbores 336.1-336.3 may be measured, drilled, tested and produced as shown in FIGS. 1.1-1.4. Stimulation operations performed at the wellsites 300.1 and 300.2 may involve, for example, perforation, fracturing, injection, and the like. The stimulation operations may be performed in conjunction with other oilfield operations, such as completions and production operations (see, e.g., FIG. 1.4). As shown, the wellbores 336.1 and 336.2 have been completed and provided with perforations 338.1-338.5 to facilitate production.

Downhole tool 306.1, 306.2 is positioned in vertical wellbore 336.1 adjacent tight gas sand reservoirs 304.1 for taking downhole measurements. Packers 307 are positioned in the wellbore 336.1 for isolating a portion thereof adjacent perforations 338.2. Once the perforations are formed about the wellbore fluid may be injected through the perforations and into the formation to create and/or expand fractures therein to stimulate production from the reservoirs.

Reservoir 304.4 of formation 302.2 has been perforated and packers 307 have been positioned to isolate the wellbore 336.2 about the perforations 338.3-338.5. As shown in the horizontal wellbore 336.2, packers 307 have been positioned at stages SET₁ and SET₂ of the wellbore. As also depicted, wellbore 304.3 may be an offset (or pilot) well extended through the formation 302.2 to reach reservoir 336.2. One or more wellbores may be placed at one or more wellsites. Multiple wellbores may be placed as desired.

Sensors and/or other measurement devices may be provided about the wellsite to collect wellsite data. Surface unit 350 may be provided to gather wellsite data at the wellsite. Other wellsite data may be collected from offsite sources, such as offsite unit 354. The surface unit 350 and offsite unit 354 may be collected by a communication link and/or network 352.

FIG. 3.2 shows an example wellsite 300.3 after stimulation. As shown in FIG. 3.2, fracture network 340 extends in layers as indicated by the fracture planes depicted as rectangles about the wellbore 304. Perforations (or perforation clusters) 342 may be formed about the wellbore 304, and fluids 344 and/or fluids mixed with proppant 346 may be injected through the perforations 342 and into the fracture network 340.

The stimulation performed using the examples of FIGS. 3.1 and 3.2 may be repeated by refracturing the wellbore. Such refracturing may involve fracturing the wellbore at other locations within the same wellbore 304, in new wellbores from the same rigs 308.1-308.3, and/or by forming new wellbores from new rigs.

### Placement of Oilfield Operations

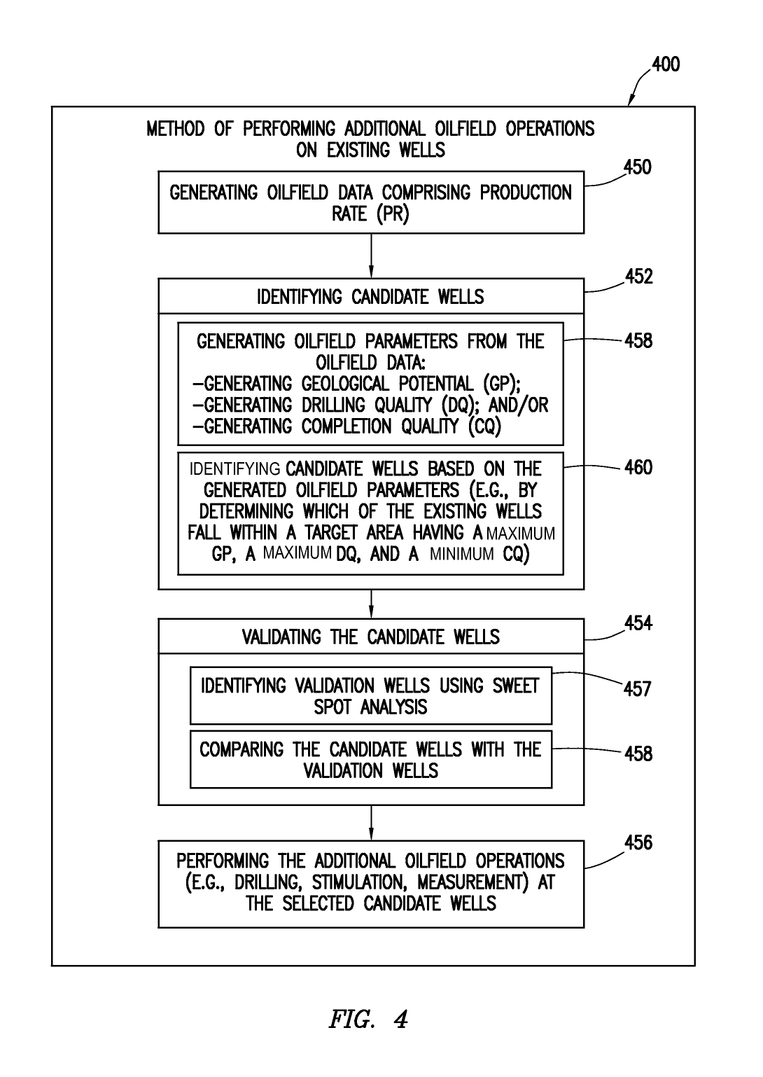

FIG. 4 is a flow chart depicting a method 400 for placement of oilfield operations. The method 400 involves 450—generating oilfield data, 452—identifying candidate wells, 454—validating candidate wells, and 456—performing the oilfield operations for the selected candidate wells. The generating (452) oilfield data and/or performing (456) the oilfield operations may be performed as described, for example, in FIGS. 1.1-3.2. Part or all of the methods described herein may be performed in various orders and repeated as desired.

The generating (450) oilfield data may involve collecting oilfield data (such as production rate) about one or more wellsites and/or processing the wellsite data. For example, oilfield data, such as production rate may be measured from existing wells. Data sets of the collected data may be formed by constructing a dataset combining data from drilling, stimulation, completion, and/or production data. Such data may also come from data sources, such as historical databases, data from other wells, production, stimulation, petrophysics, and/or other data sources on or offsite.

The data may be aggregated into one or more databases. In cases involving selection of candidates for performing oilfield operations as described herein, datasets may include, for example, initial production rates (IHS database), wellbore trajectory (IHS database), geological and geophysical (gravity and magnetic) maps from open sources, and/or other public databases. If more information, such as seismic cubes, 3D geological model is available, then the resulting completion parameters may be used to increase the quality of candidate selection.

The oilfield data may be processed (e.g., pre- or post-processed) for use with the methods herein and/or for other purposes. For example, the data may be pre-processed into a format that is analyzable and/or cleaned. Pre-processing may include, for example, slicing sub-sections of data, censoring data based on predefined conditions, randomly sampling a percentage of rows, removing outliers, dynamic time warping, and/or formatting the data into a desired form (e.g., a form that can be fed into a machine learning algorithm). The data may also be formatted for use in various software (e.g., simulation and/or modeling software, such as MANGROVE™)

### Multi-Factor Analysis

The identifying (452) candidate wells may be performed by 458—generating oilfield parameters, and 460—selecting candidate wells based on the generated oilfield parameters. The generating (460) oilfield parameters may involve determining oilfield parameters, such as geological potential (GP), drilling quality (DQ), and/or completion quality (CQ), based on the generated oilfield data.

PR may be defined as the rate of flow of hydrocarbons from the well. The GP may be defined as the reservoir quality of production. The DQ may be defined as the quality of a trajectory of a well within a target layer of a formation and/or contact between the well and a reservoir within the target layer. The CQ may be defined as an influence of completion parameters on the PR. These oilfield parameters may be used to assist in candidate identification and/or selection.

### 1. Production Rate (PR)

The PR, or rate of flow of hydrocarbons from the well, may be measured over time for a given well. Production rate may be limited by GP. Using the multi-variate approach, the PR may be described based on the GP, DQ, and/or CQ. It is assumed that PR for the model well has a multifactor nature that can be described according to the following equations:

PR=GP*(DQ*CQ) (1)

PR<=GP (2)

DQ*CQ<=1 (3)

where: GP defines an upper limit of the production rate and is in the same units as the PR; DQ is a coefficient from 0 to 1; CQ—is a coefficient from 0 to 1; DQ*CQ—is less than or equal to 1; and PR may be normalized by time and by number of fracturing stages or by horizontal length (see, e.g., FIG. 3.1).

The PR may be normalized by time and by the number of fracturing stages, or by horizontal length. PR may be described by estimating one of the quality factors (GP, DQ, and CQ) while fixing the other two.

The PR may be described based on the GP, and may be used to calculate a production index (PR_{index}). This production index may have a higher probability to define a dependency from DQ and CQ as follows:

PR_{index}=CQ*DQ (4)

where: PR_{index}<=1

The production index may be rewritten as follows:

PR_{index}=PR/GP (5)

The DQ and the CQ may be estimated according to (1) and (5) as follows:

CQ=PR_{index}/DQ (6)

If DQ is small and close to 0, equation (6) may be stabilized by adding a small number to the denominator, and by defining CQ≦1. The CQ may be estimated using the following:

CQ=(PR/GP)/(DQ+a) (7)

where α is a small number to allow the denominator to be equal to zero or very small value (e.g., about 0.01 or smaller).

### 2. Geological Potential (GP)

The GP, or reservoir quality of production, is the ability to generate hydrocarbons from a formation, and may be an assessment of various factors, such as organic richness, porosity, permeability, hydrocarbon saturation, and/or areas of higher pressure that may drive fluid flow through the rock. The GP may define an upper limit of the production rate (PR). Initially, GP may be estimated from the PR.

The multi-factor analysis may be performed by using the PR to estimate GP based on a mapping of production for a particular position on a map. For example, a location with producing wells may be selected, and a map of an area within a given radius may be generated to depict the formation and well production for such area. For this purpose, a maximum PR of the wells closest to the position may be detected. This may be performed for a defined radius around the selected location, thereby locating nearby wells capable of producing. In the multi-factor analysis, it is assumed that, within the selected location near a calculation point, a maximum PR can be used as an estimation of GP.

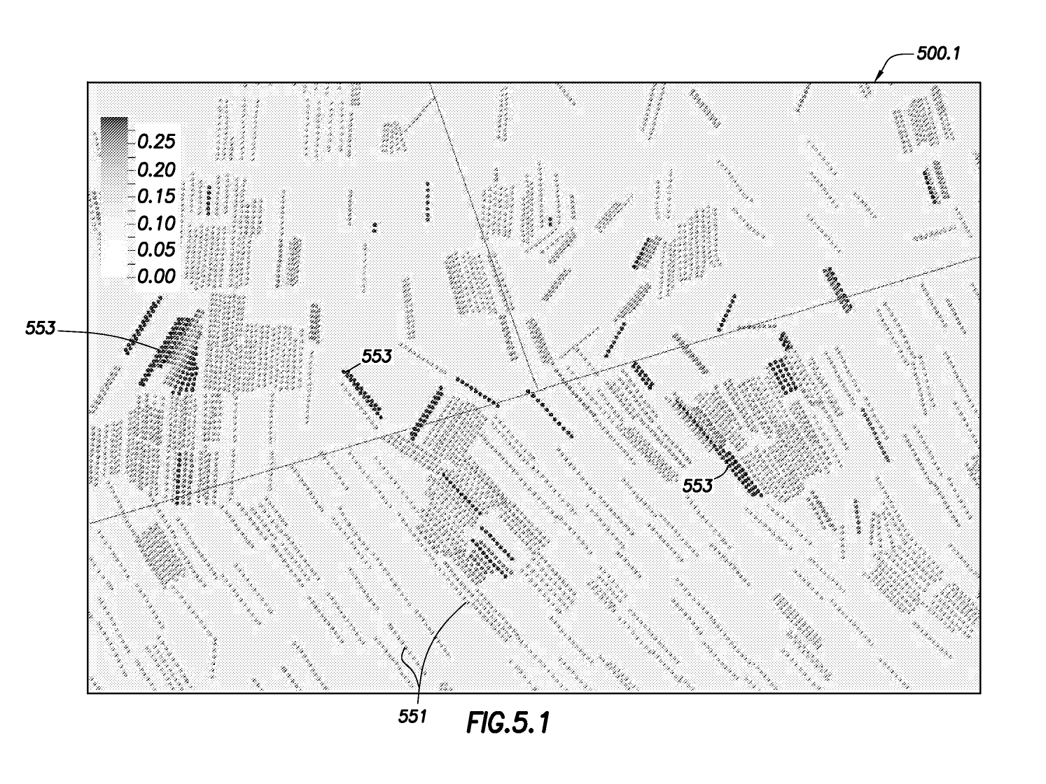

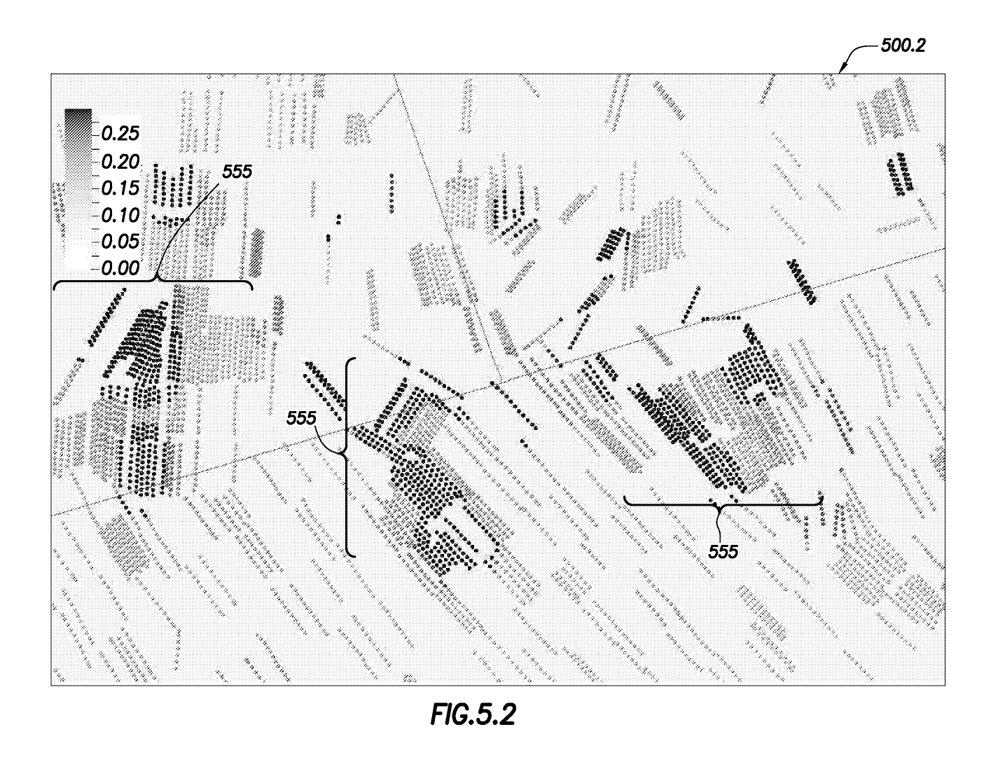

FIGS. 5.1 and 5.2 show an example estimation of the GP for a given location. This estimation uses 25% maximum values for a 10,000 ft (3048 m) search radius. Each figure shows a two dimensional map 500.1, 500.2 depicting original and maximum PR, respectively, for a formation within the search radius. Each of these figures has numerous dotted bands 551 indicating PR generated throughout the search radius. The bands 551 are shaded according to amounts of production, with darker shading indicating higher production and lighter shading indicating lower production. Each of the bands includes a series of dots indicating PR at different locations along a horizontal portion of a given well.

As indicated by FIG. 5.1, many of the bands indicate similar production rates for a horizontal portion of a well drilled into the formation. Each point along these horizontal portions of the well may be used as a separate source of oil. As indicated by FIG. 5.2, certain regions within the search area have high maximum PR, and others have lower PR. A smaller PR may be explained by other factors that decrease the PR according to Equation (1). For example, an average calculation of a defined percentage of maximum data may be used.

Using the maps of FIGS. 5.1, 5.2, the GP can be estimated for particular positions on the map based on the PR. Based on these estimations, wells near the highest maximum production may be classified as high producers 553 as shown in FIG. 5.1. An area 555 near the high producers may be selected for additional oilfield operations, such as re-fracturing, as demonstrated by FIG. 5.2. This estimation may be performed in a defined radius around any selected position that allows finding nearby wells with a calculated maximum PR. In this manner, wells may be identified as potential candidates for additional production. For example, a well with a given minimum GP may be considered acceptable.

While FIGS. 5.1 and 5.2 show maps of original and maximum PR, the multi-factor analysis may also predict possible PR using a prediction map (or 3D model) of the production rate based on various factors, such as seismic data, gravity/magnetic data and different types of geology-geophysical maps. In developing an analysis technology for production prediction, an independent dataset may be used for the prediction.

The maps may be, for example, porosity or total organic content (TOC) maps created from well log porosity and TOC values in the target interval. Such maps may not be completely independent from production where the production data may be dependent on the average porosity for the wells in the target interval. The porosity and TOC maps may have high correlation with the production data. Such maps may not be useful for predicting new areas for production where there is no additional information between wells. Other similar parameters created from well logs may also be originally dependent on production rates. On the other hand, a seismic dataset may be completely independent from production. Seismic attributes may have good correlation with production rates and may be effectively used for production prediction.

For many cases, such as for regional investigations, seismic datasets that cover all of the area of interest may not be available. In such cases, gravity and magnetic data may be used as independent observations. An inversion technique that allows us to calculate the 3D distribution of the density contrast parameters may be applied to provide a better correlation to the production data from the target layer. Examples of inversion techniques are provided in Priezzhev et al., Regional Production Prediction Technology Based On Gravity and Magnetic Data From the Eagle Ford Formation, Texas, USA, SEG Technical Program Expanded Abstracts, pp. 1354-1358 (2014), the entire contents of which are hereby incorporated by reference herein (hereafter “Priezzhev Technique”). Maximum PR may also be used for the Sweet Spot analysis, and/or to obtain a result with better QC (e.g., with higher correlation coefficients for non-used wells—production rate—a so call “blend wells test”).

### 3. Drilling Quality (DQ)

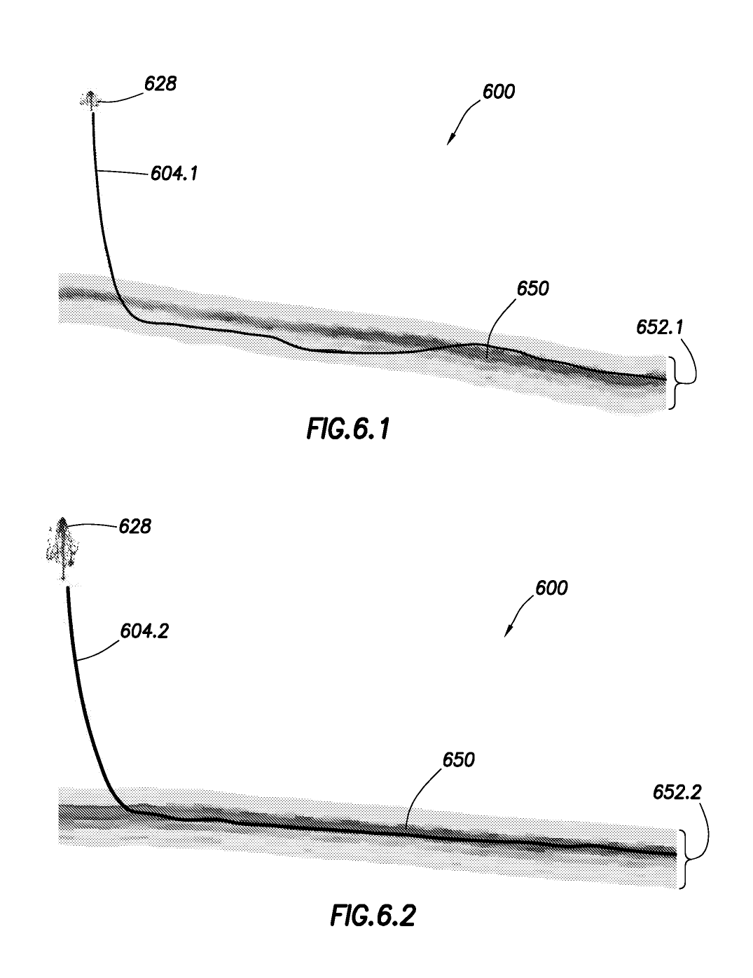

The DQ describes the quality of a position and/or a trajectory of a well within a target layer of a formation and/or contact with a reservoir within the target layer. An example DQ is depicted in FIGS. 6.1 and 6.2. FIGS. 6.1 and 6.2 are schematic diagrams depicting a wellsite 600 with wellbores 604.1, 604.2 extending from rig 628 to reach a reservoir 650.

As schematically shown, a target zone 652.1, 652.2 is defined in the formation. The target zones 652.1, 652.2 may be an indication of where to place the wellbores 604.1, 604.2 to reach the reservoir 650. In the wellbore 604.1 of FIG. 6.1, the DQ is considered poor (e.g., being about 35% contacted) due to the amount of the wellbore 604.1 that is outside of the target zone 652.1 and in non-contact with the reservoir 650. In the wellbore of FIG. 604.2, the DQ is considered good (e.g., being nearly 100% contacted) due to the amount of the wellbore 604.2 that is within the target zone 652.2 and in contact with the reservoir 650. The DQ may be considered to be acceptable at a given minimum DQ, such as the DQ of FIG. 6.2.

Several techniques may be used to quantify the DQ. First, using a ‘simple express method,’ DQ may be estimated by using a variation of the trajectory along the horizontal part of the well. When the trajectory has a high variation, meaning that it has a lot of fluctuations in the trajectory, it can be explained by many changes in the dip during the drilling, where the logs during drilling show an error in position. If the trajectory has a small variation, it may be explained by a better trajectory position during the drilling,

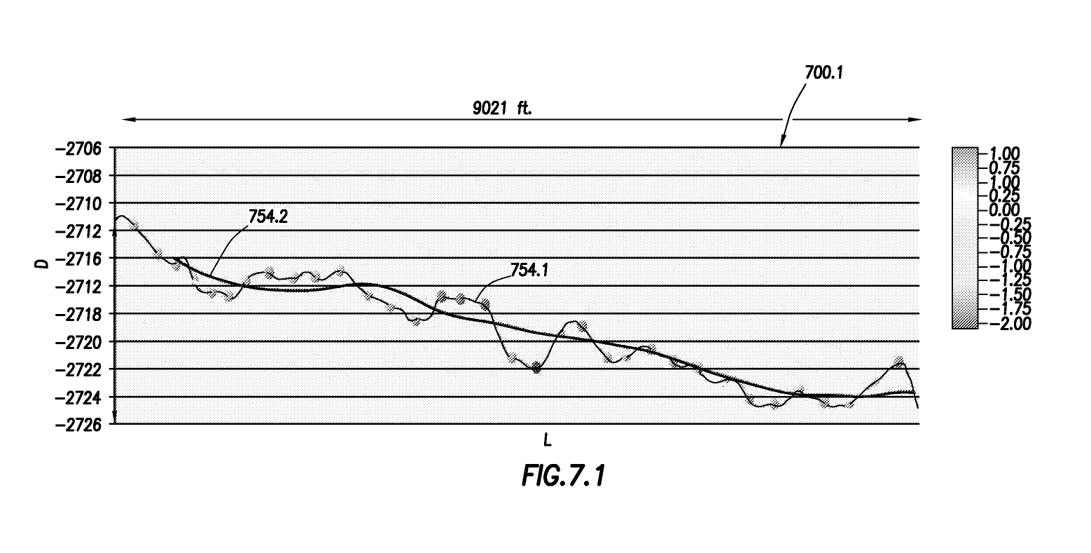

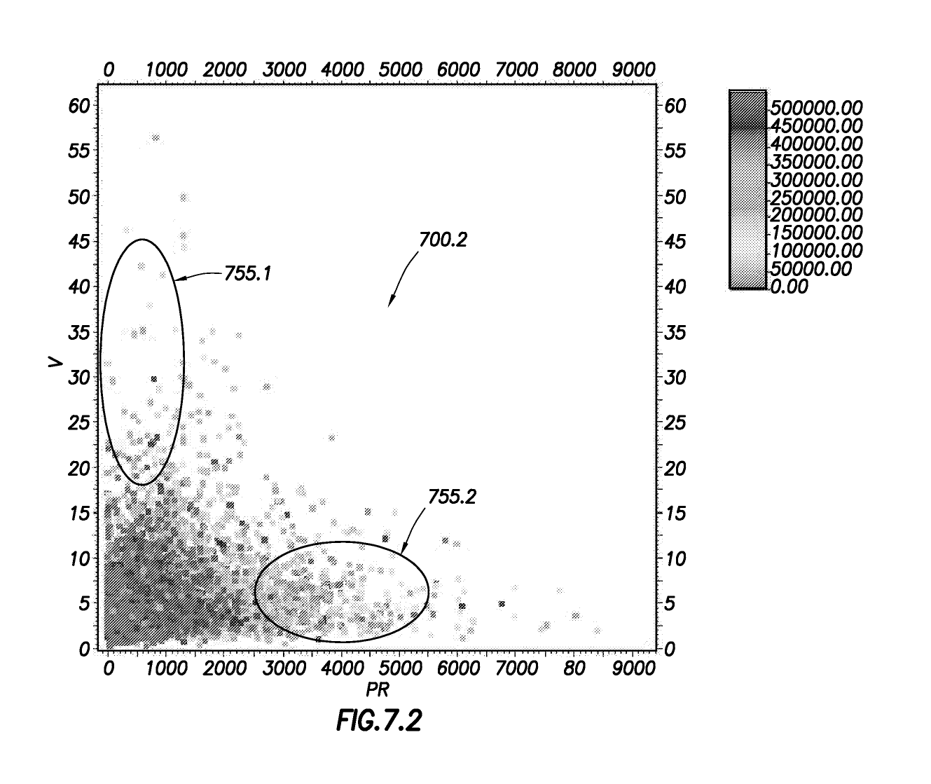

Trajectory variation may be determined using the 1^{st} or 2^{nd} derivative of the trajectory as shown in FIGS. 7.1 and 7.2. FIGS. 7.1 and 7.2 are graphs 700.1, 700.2 illustrating well trajectory variation. FIGS. 7.1 a graph showing a line 754.1 depicting trajectory variations based on variation from polynomial approximation (2nd power in this case). The line 754.1 extends over a depth D (e.g., 23 ft (7.01 m)) and length L (e.g., 9021 ft (2749.60 m)) along a portion of the trajectory 704. This well trajectory variation is depicted versus production rate for 8000 horizontal wells at a wellsite. Line 754.2 is a polynomial approximation, with points along line 754.1 indicating difference from the polynomial approximation line 754.2. The points along the line 754.1 depict distance from the defined well in good production zone.

The graph 700.2 of FIG. 7.2 shows a cross-plot of the trajectory variation (V) (y-axis) versus production rate (PR) (x-axis). This graph 700.2 depicts a cross section of the well trajectory of FIG. 7.1 using a polynomial approximation. Region 755.1 of the graph 700.2 shows bed producers having a poor (or large) trajectory variation. Region 755.2 of the graph 700.2 shows good producers having good (or small) trajectory variation. As shown by FIG. 7.2, a distance from the defined well in zone with good producers shows good negative proportional dependence of the trajectory variation versus production rate.

Other techniques may be used to calculate the trajectory variation based, for example, on drilling dip variation or on the trajectory 1st or 2nd derivative, etc. A small variation may indicate low production; whereas, high variation may indicate high production.

Second, an estimation of best production at well depth surface may be used. The best production at well depth surface may be used to calculate the variation from the surface of the trajectory of the horizontal part of the well. In this version, if the trajectory has a high degree of variation from the depth position of the best neighboring producer, then the position may be incorrect.

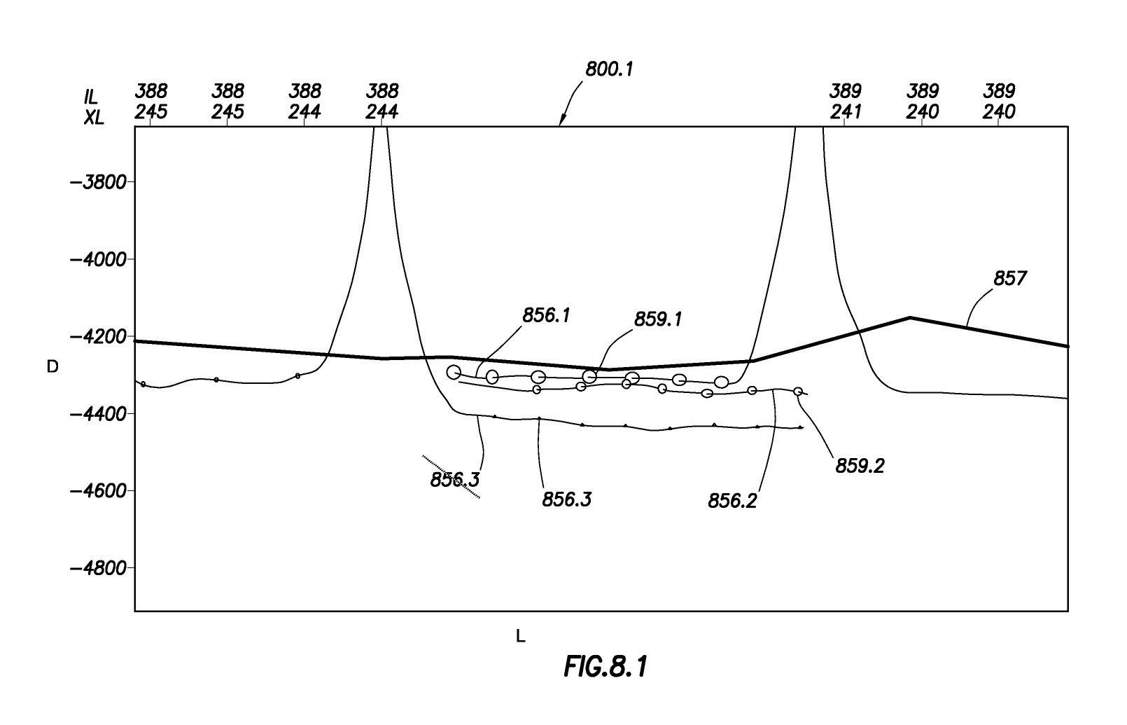

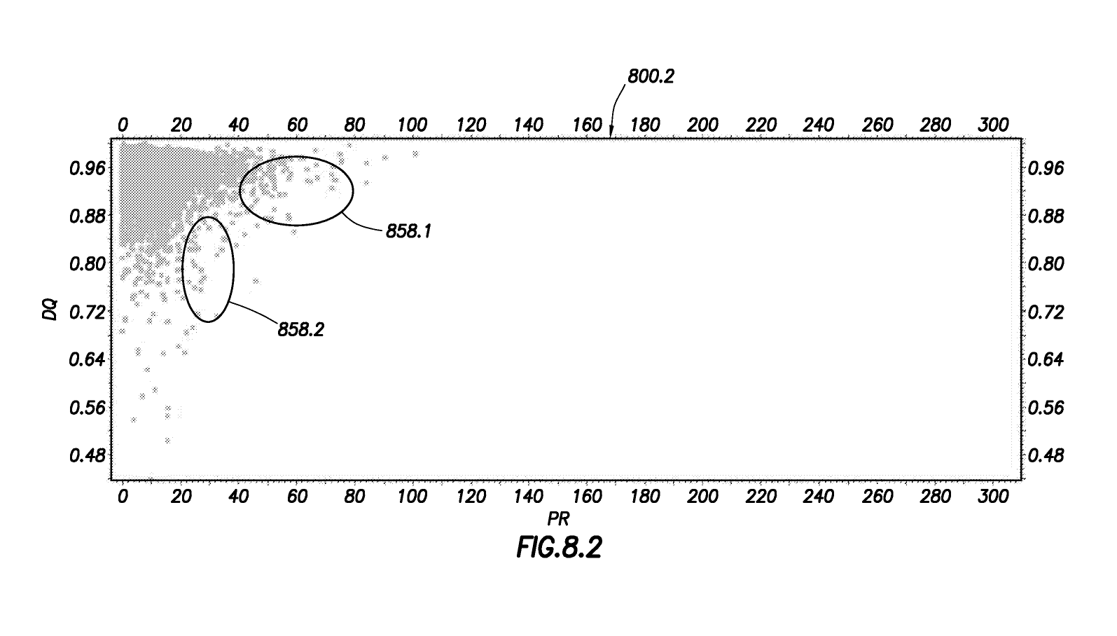

FIGS. 8.1 and 8.2 show another example of well trajectory variation used to estimate DQ based on depth. FIG. 8.1 is a plot 800.1 of a cross-section of a formation showing wells 856.1-856.3 at various depths D (y-axis) along a lengths L (x-axis). Line 857 indicates a top layer in the formation. Production for each of the wells 856.1-856.3 is indicated by points 859.1-859.3 along each well. The size of the points 859.1-859.3 indicates a quantity of production, with larger points indicating larger production and smaller points indicating smaller production.

As shown in FIG. 8.1, a shallower well 856.1 has greater production and a deeper well 856.3 has less production, with midlevel well 856.2 therebetween. Well 856.1 is considered a high producing well, with deeper wells 856.2,3 producing less. Based on this graph 800.1, the PR may be assumed to be at a maximum at the top layer 857.

FIG. 8.2 is a cross-plot 800.2 depicting drilling quality (DQ) (y-axis) versus production rate (PR) (x-axis) for the production of FIG. 8.1. In this example, good producers 858.1 have a DQ of about 1.0 and bad producers 858.2 have a DQ of about less than 0.8.

Third, based on an existing 3D model of the target layer, a zone index (1—in the layer, 0—out from the layer) may be calculated for every well in a similar manner to the 2D version of FIGS. 6.1 and 6.2. This zone index may be used to demonstrate a well trajectory position in a layer of the formation and can be used as the DQ. In this example, the zone index may be used to define the contact quality of the particular well with higher precision. Creation of this model may use additional data and time. This version may be used, for example, in cases involving local data analysis when a higher level of precision is desired and enough data for a detailed 3D model is available.

### 4. Completion Quality

The CQ describes the influence of completion parameters on PR. The CQ may depend on factors, such as stimulation, fracture job quality, volume of fluid pressure, type of proppant, etc. CQ may also be influenced by other factors, such as minerology, elastic properties, Young's modulus, Poisson's ratio, bulk modulus, rock hardness, natural fracture density and orientation, intrinsic fractured material anisotropy and magnitudes, anisotropy of in situ stresses, or other geological factors. Examples of CQ are described in Miller et al., Seeking the Sweet Spot: Reservoir and Completion Quality in Organic Shales, Oilfield Review, Winter, Vol. 25, No. 4 (2014), the entire contents of which is hereby incorporated by reference herein (hereafter “Miller”).

The CQ may be calculated during the performance of the fracturing job in a standard way based on the pressure behavior. The CQ may be determined from several completion parameters with influence on PR. The CQ may be determined, for example, based on estimations of the GP of production and the DQ.

In an example, the CQ may also be estimated from the estimated (or obtained) GP and DQ based on Equation (6) which is rewritten as follows:

CQ=(PR/GP)/DQ (8)

Thus, CQ may be directly estimated for a particular wellbore based on its PR. Where the DQ is equal (or near), a mathematical uncertainty may exist since the denominator may have a small value close to zero. A given minimum CQ may be considered acceptable.

### Selection of Candidate Wells

The selecting (460) candidate wells may be performed by determining which of the existing wells in a target area have a maximum GP, a maximum DQ, and a minimum CQ. Candidate wells (RC) can be selected based on logic. For example, a refracturing candidate may be a well that has a position with a good GP, a high DQ, and a low CQ. For example, it can be described by the following binary equation:

RC=if(GP>avg GP,1,0)*if(DQ>avg DQ,1,0)*if(CQ<avg CQ,1,0) (9)

where:
RC=1 if the well is selected as a re-fracturing candidate;
RC=0 if the well is not selected;
avg GP the average value of GP;
avg DQ is the average value of DQ (e.g., 0.5); and
avg CQ is the average value of CQ (e.g., 0.5).
   Other equations may also be used, such as continuous probability equations to identify good/bad wells for further processing (e.g., re-fracturing).

### 2. Identification

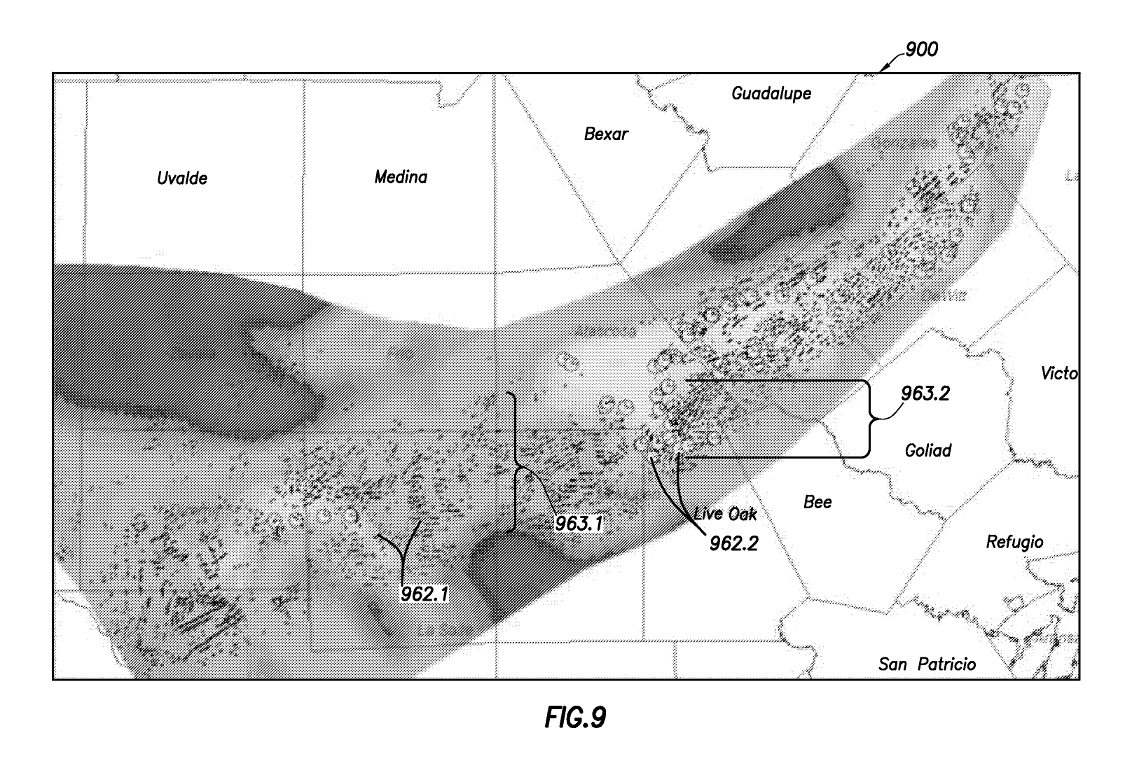

Candidate wells may be identified on a map for selection. FIG. 9 is a map 900 depicting an example mapping of a formation with 8K horizontal wells. FIG. 9 plots CQ calculated based on the DQ of FIG. 8.1 for all 8k wells of the map. As shown, for example in FIG. 9, refracturing candidates may be selected for a given location. The map 900 is shaded according to GP. Darker regions show lower GP and lighter regions show higher GP.

Wells with higher GP and/or PR may be considered a target area within the region for selection of candidate wells for refracturing and/or other oilfield operations. Wells with low potential (or poor RC) are depicted on the map as dots 962.1 with a small diameter. Wells with high potential (or good RC) are depicted on the map as bubbles 962.2 with a larger diameter.

As shown on the map 900, groups of ‘poor’ wells 962.1 fall within a ‘poor’ region 963.1 having low GP and PR, thereby failing to qualify as candidates for additional oilfield operations. Groups of ‘good’ wells 962.2 fall within a ‘good’ region 963.2 having higher GP and PR, thereby qualifying as candidates additional oilfield operations. One or more of the ‘good’ wells 962.2 within the ‘good’ region 963.2 may be identified and/or selected as candidates.

### Validation

Optionally, candidate wells chosen during the selecting (460) may be validated for confirmation. The validating (454) candidate wells may be performed by 457—identifying validation wells using another analysis technique, such as a Sweet Spot analysis or modeling, and 458—comparing the validation wells with the candidate wells.

Sweet Spot analysis may be performed using various techniques. Examples of Sweet Spot analysis are provided in in Priezzhev et al., Robust One-Step (Deconvolution+Integration) Seismic Inversion in The Frequency Domain, Proceedings of Society of Exploration Geophysicists Annual Meeting—Las Vegas (2012) and/or Cox et al., Sweet Spot Analysis Using Nonlinear Neural Network with Multivariate Input and Multivariate Output, presented at the Geoscience Conference, Banff Canada, Sep. 22-24, 2014, the entire contents of which is hereby incorporated by reference herein (hereafter “Preizzhev Sweet Spot Analysis”), and Miller previously incorporated by reference herein. The Sweet Spot analysis may be used to predict the possible PR via a prediction map or a 3D model of the PR based on seismic data, gravity/magnetic data, and/or various types of geology-geophysical maps. An independent dataset may be used when developing the analysis technology for production prediction.

In an example, Sweet Spot analysis may be performed by comparing production (e.g., overproducing and underproducing) of wells within a region. The Sweet Spot analysis may involve identifying wells within an area that have different PR compared to the predicted PR of a modeled well. A regression model may be used to identify which wells are over/under producing. A residual analysis may be performed by subtracting the model output from the actual measurements collected by the sensors.

Modeling may also be used to generate candidate wells using, for example, existing modeling software, such as MANGROVE. Such software may use a variety of methods, such as production rate, to generate the candidate wells for comparison to the candidate wells generated using the multi-factor method herein.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for performing additional oilfield operations on existing wells, the existing wells extending into a subterranean formation, the existing wells having oilfield operations previously performed to generate production, the method comprising:
generating production rate of the existing wells in a target area;
generating oilfield parameters for each of the existing wells in the target area, the oilfield parameters comprising geological potential, drilling quality, and completion quality;
identifying candidate wells from the existing wells by determining which of the existing wells within the target area have a maximum geological potential, a maximum drilling quality, and a minimum completion quality; and
performing the additional oilfield operations on at least one of the identified wells to generate new production.

2. The method of claim 1, wherein the additional oilfield operations comprise at least one of re-perforating, re-stimulating, re-injecting, and re-fracturing.

3. The method of claim 1, wherein the additional oilfield operations comprise at least one re-drilling, re-completing, and combinations thereof

4. The method of claim 1, further comprising validating the candidate wells by identifying validation wells using a Sweet Spot analysis and comparing the candidate wells with the validation wells.

5. The method of claim 1, wherein the generating geological potential comprises the maximum production rate of the candidate wells.

6. The method of claim 1, wherein the generating geological potential comprises locating the existing wells with high production and classifying the existing wells within a radius of the located existing wells as having the minimum geological potential.

7. The method of claim 1, wherein the generating the drilling quality comprises determining contact of the existing well within a target zone and classifying wells with a maximum trajectory variation as having the maximum drilling quality.

8. The method of claim 1, wherein the generating the drilling quality comprises determining a trajectory variation of the existing wells and classifying wells with a maximum trajectory variation as having the maximum drilling quality.

9. The method of claim 8, wherein the trajectory variation is determined using at least one of a polynomial approximation, drilling dip variation, first derivative of the trajectory, second derivative of the trajectory, and combinations thereof.

10. The method of claim 1, wherein the determining the drilling quality is based on a depth of the existing wells.

11. The method of claim 1, wherein the completion quality is generated from the production rate, geological potential, and drilling quality.

12. A method for performing additional oilfield operations on existing wells, the existing wells extending into a subterranean formation, the existing wells having oilfield operations previously performed to generate production, the method comprising:
generating oilfield data for each of the existing wells in a target area, the oilfield data comprising production rate;
generating oilfield parameters for each of the existing wells in the target area, the oilfield parameters comprising geological potential, drilling quality, and completion quality;
identifying candidate wells from the existing wells by determining which of the existing wells within the target area have a maximum geological potential, a maximum drilling quality, and a minimum completion quality; and
performing the additional oilfield operations on at least one of the identified wells to generate new production.

13. The method of claim 12, wherein the generating oilfield data comprises measuring production rate of the existing wells.

14. A method for performing additional oilfield operations on existing wells, the existing wells extending into a subterranean formation, the existing wells having oilfield operations previously performed to generate production, the method comprising:
generating oilfield data for each of the existing wells in a target area, the oilfield data comprising production rate;
generating oilfield parameters for each of the existing wells in the target area, the oilfield parameters comprising geological potential, drilling quality, and completion quality;
identifying candidate wells from the existing wells by determining which of the existing wells within the target area have a maximum geological potential, a maximum drilling quality, and a minimum completion quality; and
re-stimulating at least one of the identified candidate wells.

15. The method of claim 14, wherein the re-stimulating comprises perforating the identified wells and injecting fluids from the identified candidate wells into the subterranean formation.
